(19) United States
(12) Patent Application Publication
(10) Pub. No.: US 2016/0333759 A1
(43) Pub. Date: Nov. 17, 2016

(54) METHOD OF OPERATING AN AFTERTREATMENT DEVICE IN AN AUTOMOTIVE SYSTEM

(71) Applicant: GM GLOBAL TECHNOLOGY OPERATIONS LLC, Detroit, MI (US)

(72) Inventor: Davide DI NUNNO, Torino (IT)

(73) Assignee: GM GLOBAL TECHNOLOGY OPERATIONS LLC, Detroit, MI (US)

(21) Appl. No.: 15/154,468

(22) Filed: May 13, 2016

(30) Foreign Application Priority Data
May 14, 2015 (GB) 1508331.4

(51) Int. Cl. F01N 3/20; F02B 37/24; F01N 3/021

(52) U.S. Cl. CPC F01N 3/2006; F01N 3/021; F01N 3/2066; F02B 37/24

(57) ABSTRACT

A method of operating an aftertreatment device in an automotive system. The aftertreatment device includes a catalytic element suitable to be crossed by an exhaust gas flow. A selected portion of the catalytic element is warmed-up earlier than the rest of the catalytic element to a temperature higher than or equal to an activation temperature value for activating an exothermic reaction in the exhaust gas flow.

### CROSS-REFERENCE TO RELATED APPLICATION

This application claims priority to Great Britain Patent Application No. 1508331.4, filed May 14, 2015, which is incorporated herein by reference in its entirety.

### TECHNICAL FIELD

The present disclosure pertains to a method of operating an aftertreatment device in an automotive system and a related aftertreatment device. In particular, the present disclosure relates to a method for quickly warming-up the aftertreatment device and the related aftertreatment device.

### BACKGROUND

An internal combustion engine, particularly a diesel engine, is normally provided with an exhaust gas after-treatment system, for reducing and/or removing the combustion by-products from the exhaust gas emitted by the engine, before discharging it in the environment.

The after-treatment system generally includes an exhaust gas line for directing the exhaust gas from the internal combustion engine to the environment and one or more exhaust aftertreatment devices located in the exhaust gas line. The aftertreatment devices may be any device configured to change the composition of the exhaust gases, for example by means of exothermic converting reactions. Some examples of aftertreatment devices include catalytic converters, such as a Diesel Oxidation Catalyst (DOC), for oxidizing hydrocarbon (HC) and carbon monoxides (CO) into carbon dioxide (CO₂) and water (H₂O), a Diesel Particulate Filter (DPF), for removing diesel particulate matter or soot from the exhaust gases, a Selective Catalytic Reduction (SCR) system and/or a Lean NOₓ Trap (LNT), which are provided for trapping and/or converting nitrogen oxides NOₓ contained in the exhaust gas.

An aftertreatment device generally includes a casing and a catalytic element located therein. The catalytic element includes a catalyst support or substrate, usually a ceramic monolith with a honeycomb structure, and a washcoat, i.e. a carrier for a catalyst which is typically a mix of precious metals, such as Platinum, Rhodium, Palladium and/or other precious metals.

Although these aftertreatment devices are promising for controlling exhaust emissions, they are not effective until they are heated up to a predefined operating or activation temperature. Therefore a quick warm-up of the catalytic element would be desirable. In order to quickly reach the predefined activation temperature, a first known solution is to cause an increasing of the exhaust gas temperature and a second known solution is to increase the concentration of precious metals of the catalyst. However, with the first solution an increasing of the fuel consumption is observed, due to the greater quantity of burned fuel which does not create torque, whereas the second solution leads to a rising in costs involved with the manufacturing of the catalytic element.

### SUMMARY

In accordance with the present disclosure a method is provided for quickly warming-up the catalytic element of an aftertreatment device and a relative catalytic element which allows, at the same time, a decreasing of the fuel consumption and of the costs involved in the catalytic element manufacturing. In particular, an embodiment of the disclosure provides a method of operating an aftertreatment device in an automotive system, wherein the aftertreatment device includes a catalytic element suitable to be crossed by an exhaust gas flow such that a selected portion of the catalytic element earlier than the rest of the catalytic element is heated to a temperature higher than or equal to an activation temperature value for activating an exothermic reaction in the exhaust gas flow. As a result, the relatively small selected portion of the catalytic element may reach the activation temperature earlier than the rest of the catalytic element, allowing an earlier starting of the exothermic converting reactions of the exhaust gases. The heat produced in that selected portion by the early exothermic converting reactions, is able to warm-up (by thermal conduction) and quickly reach the activation temperature also in the rest of the catalytic element, without an appreciable increasing of fuel consumption and of the manufacturing costs. Thus, an efficient and quick conductive heat energy transferring of the heat produced in the selected portion into the rest of the catalytic element may be achieved.

According to an embodiment of the present disclosure, the warming-up of the selected portion is achieved by increasing an average concentration of a catalyst substance located in the selected portion of the catalytic element with respect to the average concentration of the catalyst substance in the rest of the catalytic element. This aspect of the present disclosure provides a simple and practical solution to actuate the early warm-up of the catalytic element, limiting the costs involved in the manufacturing of the catalytic element and without affecting the fuel consumption.

According to a further embodiment of the present disclosure, the warming-up of the selected portion is operated by the step of directing the overall exhaust gas flow into the selected portion. In this way, a great quantity of exhaust gas passes through the selected portion causing an early increasing of the temperature of the catalyst located in that selected portion. Therefore, also this aspect of the present disclosure provides a simple and practical solution to actuate the early warm-up of the catalytic element, without affecting the costs involved in the manufacturing of the catalytic element and the fuel consumption.

According to an embodiment of the present disclosure, the warming-up of the selected portion is operated by the step of increasing the speed of the exhaust gas flow passing through the selected portion. It is observed that a speed increasing of the exhaust gases leads to an increasing of the convective heat transfer coefficient between the catalyst surface and the moving exhaust gases. Therefore, in this way it is allowed a more efficient and quick heat energy convective transferring from the exhaust gas to the catalyst located in that selected portion, which causes a rising of the temperature of that selected portion.

According to another aspect of the present disclosure, the step of directing the exhaust gas flow toward the selected portion and/or the step of increasing the speed of the exhaust gas flow passing through the selected portion is operated by the actuation of a shutter located upstream of the selected portion of the catalytic element. The shutter may therefore be operated in such a way to temporally reduce the cross area for the exhaust gas, directing the exhaust gas flow toward the smaller selected portion of the catalytic element and causing an increasing of the exhaust gas speed downstream of the shutter into that selected portion. As explained above, in this way it is allowed a more efficient and quick heat energy convective transferring from the exhaust gas to the catalyst located in that selected portion, which causes a rising of the temperature of that selected portion.

According to another embodiment of the present disclosure, the warming-up of the selected portion is operated by means of an heating element, preferably the heating element includes an electrical resistance. This aspect of the present disclosure provides a simple and practical solution to actuate the early warm-up of the catalytic element, without considerably affecting the costs involved in the manufacturing of the catalytic element and of the fuel consumption. As a matter of fact, a quick and efficient heating of the selected portion up to the activation temperature may by actuated in an independent way with respect to the temperature and the quantity of the exhaust gases and/or the speed of exhaust gas flow passing through the selected portion and with respect to the concentration of the precious metals of the catalyst located in that selected portion.

Another embodiment of the present disclosure provides an aftertreatment device for internal combustion engine including a catalytic element, suitable to be crossed by an exhaust gas flow. A selected portion of the catalytic element is configured to be warmed up earlier than the rest of the catalytic element to a temperature higher than or equal to an activation temperature value for activating an exothermic reaction in the exhaust gas flow. As a result, the relatively small selected portion of the catalytic element may reach the activation temperature earlier than the rest of the catalytic element, allowing an earlier starting of the exothermic converting reactions of the exhaust gases. The heat produced in that selected portion, by the early exothermic converting reactions too, is able to warm-up and quickly reach the activation temperature also in the rest of the catalytic element, without an appreciable increasing of fuel consumption and of the manufacturing costs.

According to an embodiment of the present disclosure, the catalytic element includes a catalyst substance coating a catalyst substrate, and a catalyst substance located in the selected portion of the catalytic element. The average concentration of the catalyst substance located in the selected portion is greater than the average concentration of the catalyst substance in the rest of the catalytic element. This aspect of the present disclosure provides a simple and practical solution to actuate the early warm-up of the catalytic element, limiting the costs involved in the manufacturing of the catalytic element and without affecting the fuel consumption.

In alternative or in addition, according to a further embodiment of the present disclosure, a shutter located upstream of the selected portion of the catalytic element is used to warm up the selected portion of the catalyst element. The shutter is movable in order to reduce an entry area for the exhaust gas flow into the catalytic element and to direct the overall exhaust gas flow toward the selected portion of the catalytic element. In this way, a great quantity of exhaust gas passes through the selected portion causing an early increasing of the temperature of the catalyst located in that selected portion. Therefore, this aspect of the present disclosure provides a simple and practical solution to actuate the early warm-up of the catalytic element, without affecting the costs involved in the manufacturing of the catalytic element and the fuel consumption.

As a matter of fact, the shutter may therefore be operated in such a way to temporally reduce the cross area for the exhaust gas, causing an increasing of the exhaust gas speed downstream of the shutter into the selected portion. It is also observed that a speed increasing of the exhaust gases leads to an increasing of the convective heat transfer coefficient between the catalyst surface and the moving exhaust gases. Therefore, in this way it is allowed a more efficient and quick heat energy convective transferring from the exhaust gas to the catalyst located in that selected portion that causes a rising of the temperature of that selected portion.

In alternative or in addition, according to a still further embodiment of the present disclosure, an electrical resistance element may be included in the selected portion of the catalytic element. This aspect of the present disclosure provides a simple and practical solution to actuate the early warm-up of the catalytic element, without considerably affecting the costs involved in the manufacturing of the catalytic element and of the fuel consumption. As a matter of fact, a quick and efficient heating of the selected portion up to the activation temperature may by actuated in an independent way with respect to the temperature and the quantity of the exhaust gases and/or the speed of exhaust gas flow passing through the selected portion and with respect to the concentration of the precious metals of the catalyst located in that selected portion.

A further embodiment of the present disclosure provides an internal combustion engine including an aftertreatment device, as described above. A still further embodiment of the present disclosure provides an automotive system, in particular a passenger car, including an internal combustion engine as described above.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 is a partial-sectioned perspective view of a first embodiment of a catalytic element of the present disclosure;

FIGS. 4 and 5 are respective schematic views of an exhaust gas line provided with a first example of a second embodiment of the catalytic element of the present disclosure;

FIGS. 6 and 7 are respective schematic views of an exhaust gas line provided with a second example of the second embodiment of the catalytic element of the present disclosure;

FIG. 8 is a section view along section line VIII-VIII of FIG. 6;

FIG. 9 is a section view along section line IX-IX of FIG. 7; and

FIG. 10 is an partial-sectioned perspective view of a third embodiment of the catalytic element of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

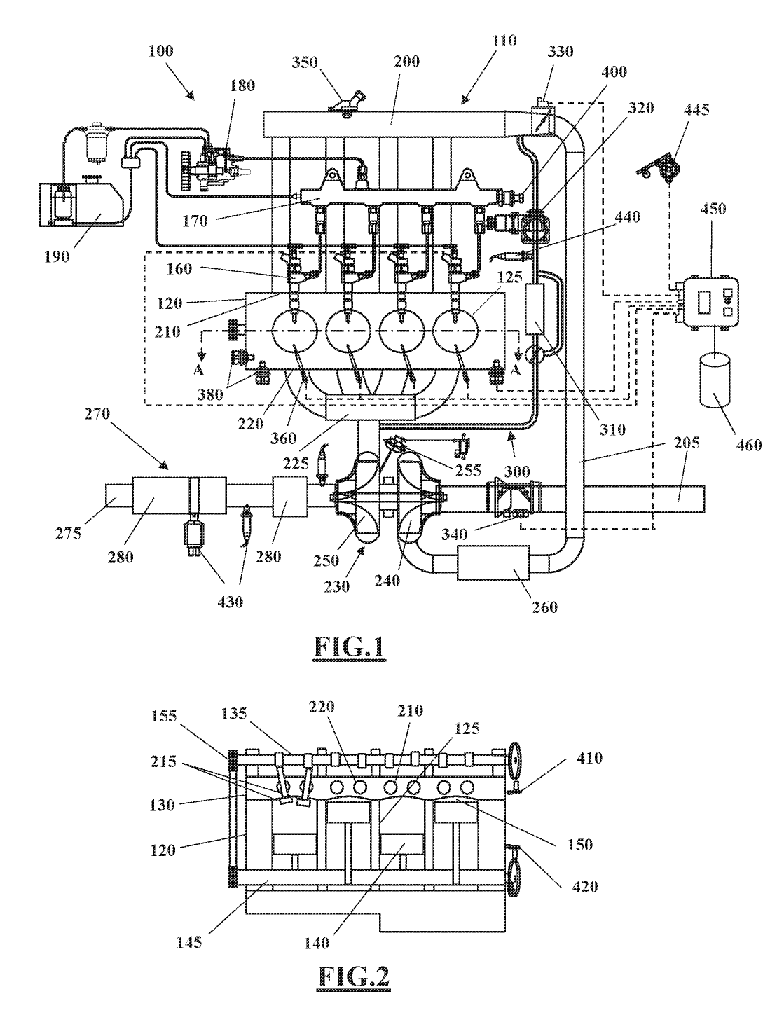

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150.

A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190.

Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle valve 330 may be provided to regulate the flow of air into the intake manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air.

The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust gas aftertreatment system 270. This example shows a variable geometry turbine (VGT) 250 with a VGT actuator 255 arranged to move the vanes to alter the flow of the exhaust gases through the turbine 250.

The exhaust gas aftertreatment system 270 may include an exhaust gas line 275 having one or more exhaust aftertreatment devices 280. The aftertreatment devices 280 may be any device configured to change the composition of the exhaust gases. Some examples of aftertreatment devices 280 include, but are not limited to, catalytic elements (two and three way), oxidation catalysts, lean NOx traps, hydrocarbon adsorbers, selective catalytic reduction (SCR) systems, and particulate filters. In the example shown in figures, the aftertreatment devices 280 include an oxidation catalyst (i.e. Diesel Oxidation Catalyst, DOC) 281 located in the exhaust gas line 275. Moreover the aftertreatment devices 280 include a particulate filter (i.e. a Diesel Particulate Filter, DPF) 282 located in the exhaust gas line 275 downstream of the DOC 281. Again, the aftertreatment devices 280 include a selective catalytic reduction (SCR) system 283 located in the exhaust gas line 275 downstream of the DPF 282.

Other embodiments may include an exhaust gas recirculation (EGR) duct 300 coupled between the exhaust manifold 225 and the intake manifold 200. The EGR duct 300 may include an EGR cooler 310 to reduce the temperature of the exhaust gases in the EGR duct 300. An EGR valve 320 regulates a flow of exhaust gases in the EGR duct 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow, pressure, temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445.

Furthermore, the ECU 450 may generate output signals to various control devices that are arranged to control the operation of the ICE 110, including, but not limited to, the fuel injector 160, the throttle valve 330, the EGR Valve 320, the VGT actuator 290, the waste gate actuator 252 and the cam phaser 155. Note, dashed lines are used to indicate communication between the ECU 450 and the various sensors and devices, but some are omitted for clarity.

Turning now to the ECU 450, this apparatus may include a digital central processing unit (CPU 460) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, the carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulated technique such as QPSK for digital data, such that binary data representing the computer program code is impressed on the transitory electromagnetic signal. Such signals are e.g. made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

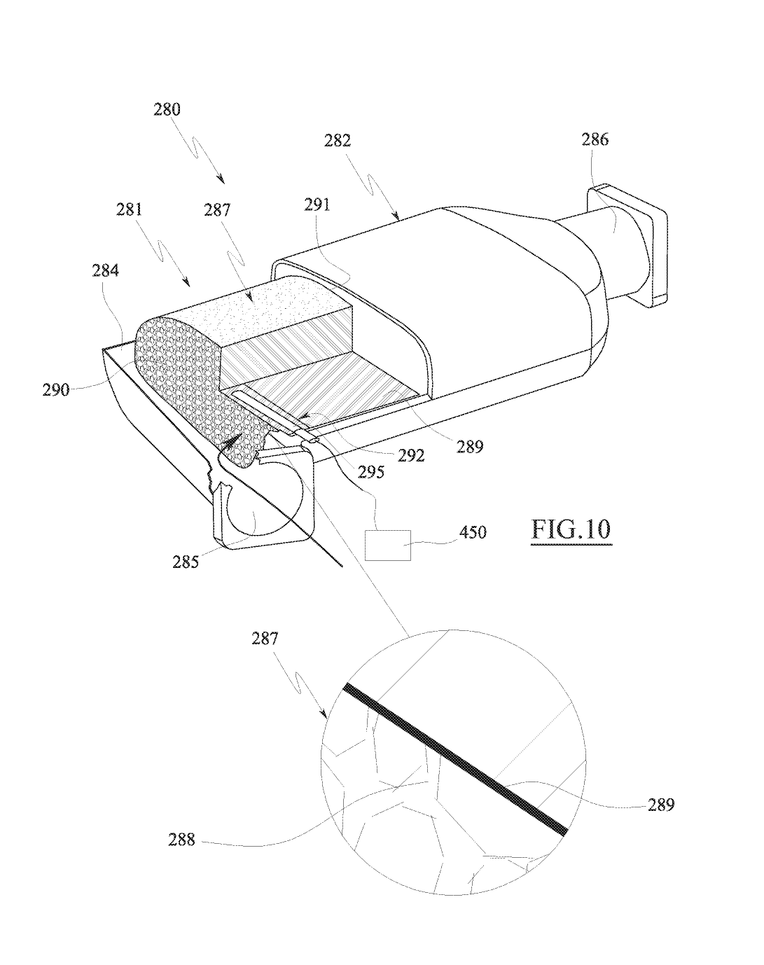

Turning now to the exhaust gas aftertreatment system 270, an aftertreatment device 280, for example the DOC 281, includes a casing 284 having an inlet duct 285 for the entry of the exhaust gas coming from the combustion chamber 150 and an outlet duct 286 for the exit of the exhaust gas. Moreover, the aftertreatment device 280, for example the DOC 281, includes a catalytic element 287 located into the casing 284 in such a way to be crossed by the exhaust gas flow flowing from the inlet duct 285 toward the outlet duct 286. As schematically shown in the enlargement of FIG. 10, the catalytic element 287 includes a catalyst substrate 288, for example a ceramic monolith with a honeycomb structure, coated with a catalyst or catalyst substance 289, which is typically a precious metal, such as Platinum, Rhodium, Palladium and/or other precious metals and mixture thereof. In one configuration , the catalytic element 287 has a cylindrical shape having a circular or elliptic cross section. The catalytic element 287 has two opposite external porous faces, in particular the catalytic element 287 has a first face 290 facing toward the inlet duct 285, from which the exhaust gas enters the catalytic element 287, and an opposite second face 291 facing the outlet duct 286, from which the exhaust gas—which has crossed the internal core of the catalytic element 287—exits the catalytic element itself.

In accordance with the present disclosure the aftertreatment device includes means for warming-up a selected portion of the catalytic element earlier than the rest of the catalytic element to a temperature higher than or equal to an activation temperature value for activating an exothermic reaction in the exhaust gas flow. The structure, act and/or materials associated various means for warming-up a selected portion of the catalytic element are hereinafter described in terms of specific chemical, mechanical and electrical embodiments.

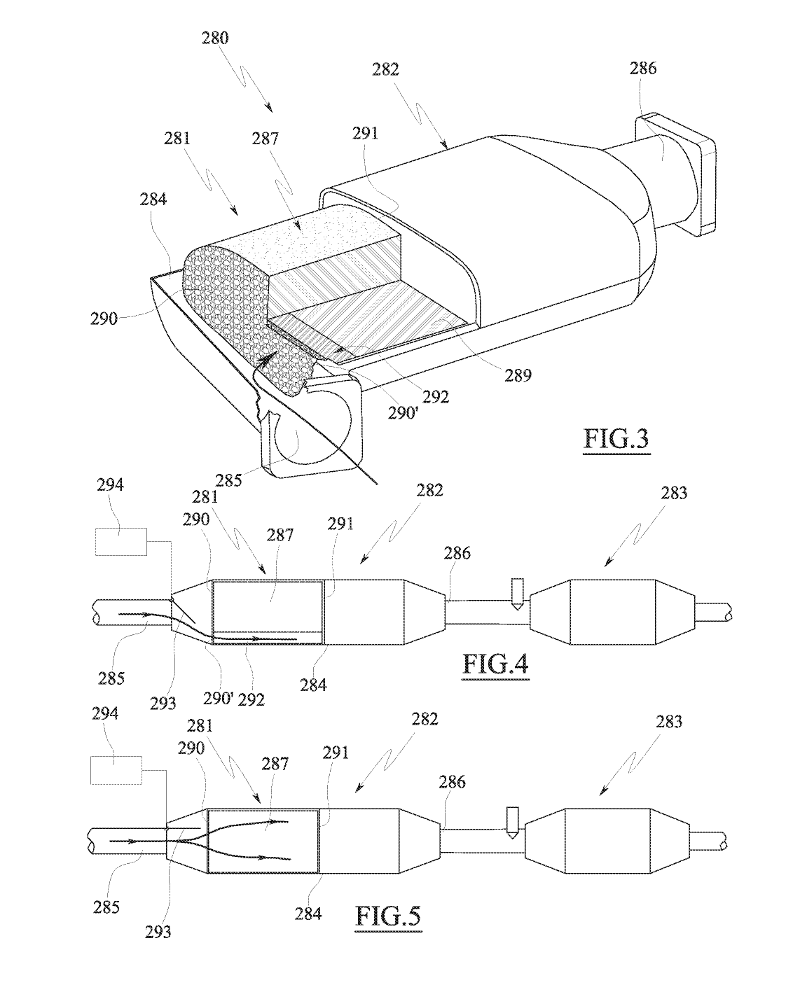

According to a first embodiment shown in FIG. 3, a selected portion 292 of the catalytic element 287 includes an average concentration of catalyst substance 289, for example of a precious metal such as one or more of the platinum-group metals (abbreviated as the PGMs), greater than the average concentration of the same catalyst substance 289 in the remainder of the catalytic element 287 (obtained by the overall catalytic element 287 from which is subtracted the selected portion 292).

The selected portion 292 is smaller than the overall catalytic element 287 and is, preferably, a portion of the catalytic element 287 including an area 290′ of the first face 290 or a core portion being, preferably but not limited to, close to the area 290′ (e.g. immediately downstream of the area 290′). For example, the selected portion 292 is a cylindrical sector of the catalytic element 287. The selected portion 292, being a partition of the same overall catalytic element 287, is thermally in contact with the rest of the catalytic element 287, in particular a conductive heat transferring between the selected portion 292 and the rest of catalytic element 287 is allowed.

When the exhaust gas flow enters the first face 290 of the catalytic element 287, it crosses the selected portion 292 too and the increased quantity of precious metals encountered by the exhaust gases causes a quicker increasing in temperature of the catalytic element 287 constituting that selected portion 292 with respect to the rest of the catalytic element 287. The temperature of the catalytic element 287 located in the selected portion 292 reaches and exceeds an activation temperature value, characteristic of the precious metal used as the catalyst substance and responsible of the activation of exothermic converting reactions in the exhaust gas, earlier than in the rest of the catalytic element 287.

In particular, the heating of the selected portion 292 caused by the precious metal enriched volume or area of the catalytic element 287 and by the exothermic converting reactions staring therein, produces heat energy which is able to warm-up the rest of the catalytic element 287. In particular, the heat energy produced in the selected portion 292 is transferred, by thermal conduction, from the selected portion 292 of the catalytic element 287 to the rest of the catalytic element 287.

According to a second embodiment shown in FIGS. 4-7, the aftertreatment device 280, for example the DOC 281, includes a shutter 293, which may be located on the casing 284 upstream of the catalytic element 287. The shutter 293 may be fixed to the inlet duct 285 in such a way to regulate the cross area of the same. In practice, the shutter 293 is movable between a closed position (for example shown in FIGS. 4 and 8), wherein the cross area of the inlet duct 285 is minimum (however different from zero), and an open position (for example shown in FIGS. 5 and 9), wherein the cross area of the inlet duct 285 is maximum (for example equal to the internal diameter of the inlet duct 285).

The shutter 293 is actuated by a shutter actuator 294 operably coupled with the ECU 450 from which receives signals in order to move the shutter 293 selectively between the open position and the closed position. In practice, when the shutter 293 is in the closed position, the exhaust gas flow is forced to pass through the small cross area of the inlet duct 285 and is directed toward a narrow selected area 290′ of the first face 290 of the catalytic element 287.

The directed exhaust gas flow, therefore, impinges on and passes through the narrow selected area 290′ of the first face 290 of the catalytic element 287 being forced to flow along a selected portion 292 of the catalytic element 287 smaller than the overall catalytic element 287.

In particular, the selected portion 292 in this embodiment may be defined as portion of the catalytic element 287 including the area 290′ of the first face 290 (axially facing the small cross area of the inlet duct 285 and against which the directed exhaust gas flow insists) and/or a core portion being, preferably but not limited to, close to the area 290′ (e.g. immediately downstream of the area 290′) and axially aligned with the area 290′.

Along the selected portion 292 the exhaust gas flow is more concentrated with respect to the rest of the catalytic element 287. The selected portion 292, being a partition of the same overall catalytic element 287, also in this case is thermally in contact with the rest of the catalytic element 287.

In a first example of this second embodiment shown in FIGS. 4 and 5, the shutter 293 is a tilting shutter, which is disposed, in its open position, substantially aligned with the flowing direction of the exhaust gas flow into the casing 284 and/or through the catalytic element 287 and, in its closed position, is inclined with respect to the flowing direction.

Therefore, the shutter 293 in its closed position diverts the overall exhaust gas flow toward a lateral area 290′ of the first face 290 of the catalytic element 287. For example, the selected portion 292 is a lateral cylindrical sector of the catalytic element 287.

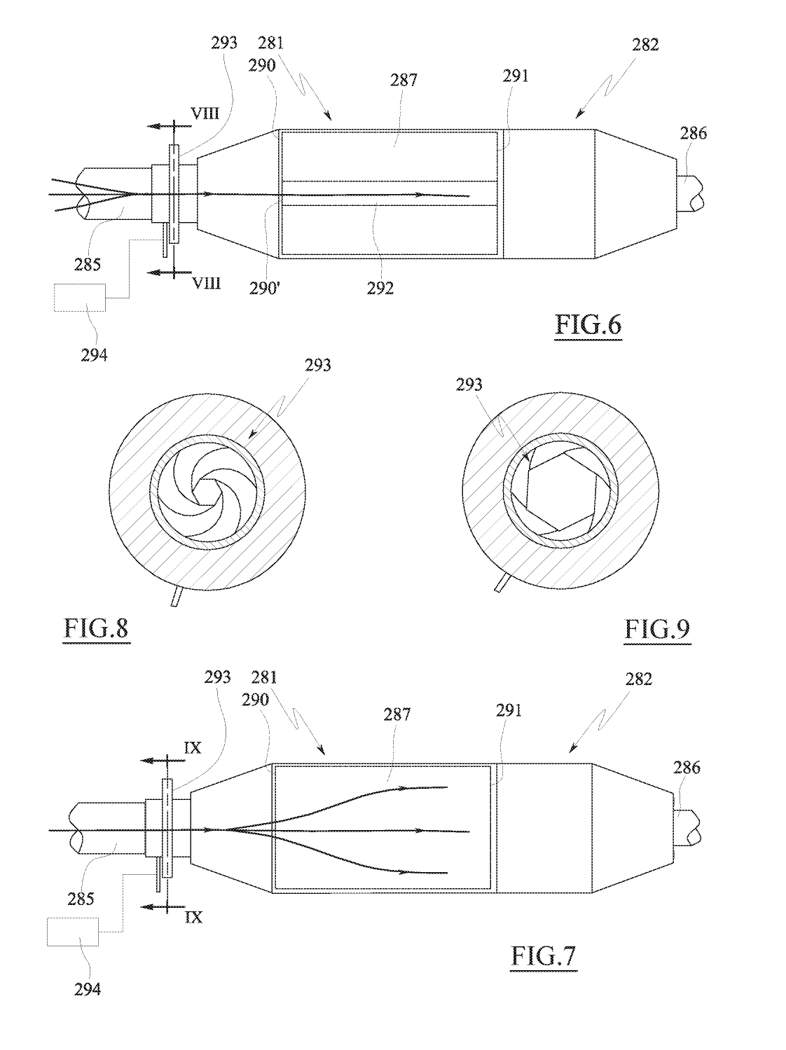

In a second example of the same second embodiment shown in FIGS. 6-9, the shutter 293 is a diaphragm shutter, which defines a small central through hole in its closed position. Therefore, the shutter 293 in its closed position diverts the overall exhaust gas flow toward a central area 290′ of the first face 290 of the catalytic element 287. For example, the selected portion 292 is a central cylindrical sector of the catalytic element 287.

When the exhaust gas flow, crossing the closed shutter 293, enters the first face 290 of the catalytic element 287 passing through the area 290′ thereof, it crosses the selected portion 292 too and the increased quantity (concentration) of exhaust gas in that narrow selected portion 292, with respect to that which crosses the rest of the catalytic element 287, causes a quicker increasing in temperature of the catalytic element 287 constituting that selected portion 292 with respect to the rest of the catalytic element 287.

Moreover, when the exhaust gas flow crosses the closed shutter 293 it increases its speed and, at the same time, the convective heat transfer coefficient between the catalyst surface and the moving exhaust gas also increases, allowing a quicker increasing in temperature of the catalytic element 287 constituting that selected portion 292.

The temperature of the catalytic element 287 located in the selected portion 292 reaches and exceeds an activation temperature value, characteristic of the precious metal used as the catalyst substance and responsible of the activation of exothermic converting reactions in the exhaust gas, earlier than in the rest of the catalytic element 287. In particular, the heating of the selected portion 292, caused by the passage of the overall exhaust gas (or the majority thereof) along the selected portion 292 and by the exothermic converting reactions starting therein, produces heat energy which may be able to warm-up the rest of the catalytic element 287. In particular, the heat energy produced in the selected portion 292 is transferred, by thermal conduction, from the selected portion 292 of the catalytic element 287 to the rest of the catalytic element 287.

According to the examples of this second embodiment, the ECU 450 is configured to operate the shutter actuator 294, in order to move the shutter 293 in the closed position during a warm-up phase, wherein the temperature of the catalytic element 287 is less than the activation temperature. In particular, the temperature of the catalytic element 287 may be measured by the exhaust pressure and temperature sensors 430 and the activation temperature may be pre-calibrated on a test bench and stored in the memory system.

According to a third embodiment shown in FIG. 10, aftertreatment device 280, for example the DOC 281, includes an heating element, for example an electrical resistance 295 inserted into the catalytic element 287 (or positioned nearby) in order to heat a selected portion 292 thereof. The selected portion 292 is defined, in this embodiment, as a surface and/or a core portion of the catalytic element 287 which encompasses and is in contact (or is proximate) to the electrical resistance 295. Moreover, the selected portion 292, being a partition of the same overall catalytic element 287, also in this case is thermally in contact with the rest of the catalytic element 287.

The temperature of the catalytic element 287 located in the selected portion 292, by means of the heating caused by the electric resistance 295, reaches and exceeds an activation temperature value, characteristic of the precious metal used as the catalyst substance and responsible of the activation of exothermic converting reactions in the exhaust gas, earlier than in the rest of the catalytic element 287. In particular, the heating of the selected portion 292 caused by the electric resistance 295 and by the exothermic converting reactions starting therein, produces heat energy which may be able to warm-up the rest of the catalytic element 287. In particular, the heat energy produced in the selected portion 292 is transferred, by thermal conduction, from the selected portion 292 of the catalytic element 287 to the rest of the catalytic element 287.

The electrical resistance 295 is actuated (indirectly or directly) by the ECU 450, in particular the ECU 450 is configured to supply electric energy to the electric resistance 295 during a warm-up phase. The temperature of the catalytic element 287 is less than the activation temperature and, for example, to interrupt the supply of the electric energy when the temperature of the catalytic element 287 reaches or exceeds the activation temperature. In particular, the temperature of the catalytic element 287 may be measured by the exhaust pressure and temperature sensors 430 and the activation temperature may be pre-calibrated on a test bench and stored in the memory system.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled)

15. A method of operating an aftertreatment device in an automotive system having a catalytic element configure to be crossed by an exhaust gas flow, the method comprises: warming-up a selected portion of the catalytic element before the rest of the catalytic element to a temperature at least equal to an activation temperature value for activating an exothermic reaction of the exhaust gas flow within the selected portion.

16. The method according to claim 15, further comprising increasing an average concentration of a catalyst substance located in the selected portion of the catalytic element with respect to an average concentration of the catalyst substance in a remainder of the catalytic element.

17. The method according to claim 15, further comprising directing an overall exhaust gas flow into the selected portion.

18. The method according to claim 17 further comprising actuating a shutter located upstream of the selected portion of the catalytic element for directing the overall exhaust gas flow into the selected portion.

19. The method according to claim 17, further comprising increasing a speed of the exhaust gas flow passing through the selected portion.

20. The method according to claim 19, further comprising actuating a shutter located upstream of the selected portion of the catalytic element for increasing the speed of the exhaust gas flow passing through the selected portion.

21. The method according to claim 15, further comprising heating a resistive element located within the selected portion of the catalytic element.

22. An aftertreatment device for internal combustion engine comprising:
a casing having an inlet and an outlet;
a catalytic element located in the casing between the inlet and outlet suitable to be crossed by an exhaust gas flow, the catalytic element having a selected portion and a remaining portion; and
means for warming-up the selected portion of the catalytic element earlier than the remaining portion of the catalytic element to a temperature at least equal to an activation temperature value for activating an exothermic reaction of the exhaust gas flow within the selected portion.

23. The aftertreatment device of claim 22, wherein the catalytic element comprises a catalyst substrate having a first catalyst substance coating in the selected portion and a second catalyst substance coating in the remaining portion, and wherein an average concentration of the first catalyst substance coating is greater than an average concentration of the second catalyst substance coating.

24. The aftertreatment device of claim 22, further comprising a shutter located upstream of the selected portion of the catalytic element and operable to reduce an entry area of the inlet for the exhaust gas flow into the catalytic element.

25. The aftertreatment device of claim 22, further comprising an heating element disposed in the selected portion of the catalytic element.

26. The aftertreatment device of claim 25, wherein the heating element comprises an electrical resistance heater.

27. An internal combustion engine comprising an aftertreatment device according to claim 22 located in an exhaust gas line.

28. An automotive system comprising an internal combustion engine according to claim 27.
